(19) United States
(12) Patent Application Publication
(10) Pub. No.: US 2026/0149105 A1
(43) Pub. Date: May 28, 2026

(54) BATTERY MODULE

(71) Applicant: Prime Planet Energy & Solutions, Inc., Tokyo (JP)

(72) Inventor: Yozo UCHIDA, Toyota-shi, Aichi-ken (JP)

(21) Appl. No.: 19/373,720

(22) Filed: Oct. 30, 2025

(30) Foreign Application Priority Data
Nov. 8, 2024 (JP) 2024-196158

(51) Int. Cl. H01M 50/264; H01M 10/0525; H01M 50/209; H01M 50/242; H01M 50/291

(52) U.S. Cl. CPC H01M 50/264; H01M 10/0525; H01M 50/209; H01M 50/242; H01M 50/291; H01M 2220/20

(57) ABSTRACT

An electricity storage module 100 includes plural electricity storage devices, a restriction member 110, and a spacer 120. The plural electricity storage devices include a pair of opposed wide width surfaces 11b1, 11b2, and the wide width surfaces 11b1, 11b2 are arranged to be opposed to each other. The restriction member 110 is configured to restrict the plural electricity storage devices in a direction along which the wide width surfaces 11b1, 11b2 of plural electricity storage devices are arranged to be opposed to each other. The spacer 120 is arranged between an electricity storage device arranged at a first end part 2a in a direction along which the plural devices are arranged and the restriction member 110, and a thickness becomes smaller when a load being larger than a predetermined load is applied along the direction in which the electricity storage devices are arranged.

### CROSS REFERENCE TO RELATED APPLICATIONS

The present application claims the benefit of priority to Japanese Patent Application No. 2024-196158 filed on Nov. 8, 2024. The entire contents of this application are hereby incorporated herein by reference.

### BACKGROUND

### Technical Field

The present disclosure relates to a battery module.

### Background Art

It is known that a secondary battery, such as lithium ion secondary battery, swells over time when an electrical charge and discharge is repeated. Japanese Patent Application Publication No. 2022-13634 discloses a technique related to a battery pack. The battery pack disclosed by this publication includes plural single batteries, plural plate-shaped spacers, and an insulating member that is different from these spacers and that is provided between these spacers. The plural single batteries have an outer shape formed to be rectangular, and restricted under a state of being arranged in a predetermined arrangement direction. Between the single batteries, 2 plate-shaped spacers are arranged to be opposed to each other. The insulating member has a hardness being higher than the spacer, and is provided, at plural points between the spacers arranged between the single batteries, to come into contact with each of 2 spacers sandwiching the insulating member. The insulating member has a thickness in the arrangement direction, while the thickness does not allow the insulating member to penetrate the spacer, even in a situation where a restriction load is increased and thus a distance between the 2 spacers become the minimum. That publication describes that, by doing this, in a situation where an expansion of the single battery occurs by the electrical charge and discharge and further the expansion of the single battery occurs by the aging degradation so that the restriction load is increased, the insulating member having the hardness being higher than the spacer sinks into the spacer so that the restriction load can be suppressed from being increased beyond expectation.

Japanese Patent Application Publication No. 2022-77843 discloses a battery module including a laminate body that consists of plural battery cells being laminated, while each battery cell includes a negative electrode containing a lithium metal or a lithium-containing metal. Regarding the battery module described above, a fixing member is provided at a center in a laminate direction. This fixing member fixes the battery cell positioned at both sides of the fixing member in the laminate direction.

Japanese Patent Application Publication No. 2023-116166 discloses plural battery cells aligned in a first direction. On a housing configured to accommodate these plural battery cells, electrode terminals (a positive electrode terminal and a negative electrode terminal) are formed to align along a second direction being orthogonal to the first direction. According to the battery module as described above, a side surface part of the housing can directly support the laminate body of the battery cells.

### PRIOR ART DOCUMENT

### Patent Document

[Patent Document 1] Japanese Patent Application Publication No. 2022-13634

[Patent Document 2] Japanese Patent Application Publication No. 2022-77843

[Patent Document 3] Japanese Patent Application Publication No. 2023-116166

### SUMMARY OF INVENTION

### Technical Problem

Anyway, the present inventor thinks to improve a situation where the restriction load of the electricity storage module becomes too larger by the swell of the electricity storage device.

### Solution to Problem

The herein disclosed electricity storage module includes plural electricity storage devices, a restriction member, and a spacer. The plural electricity storage devices include a pair of opposed wide width surfaces, and the wide width surfaces are arranged to be opposed to each other. The restriction member is configured to restrict the plural electricity storage devices in a direction along which the plural electricity storage devices are arranged to make the wide width surfaces be opposed to each other. The spacer is arranged between the electricity storage device arranged at a first end part in the arranged direction among the plural devices and the restriction member. In addition, a thickness of the spacer becomes smaller when a load being larger than a predetermined load is applied along the arranged direction.

According to the above described electricity storage module, it is possible to improve the situation where the restriction load of the electricity storage module becomes too larger by the swell of the electricity storage device.

### BRIEF DESCRIPTION OF DRAWINGS

FIG. 1 is a perspective view that schematically shows an electricity storage module.

FIG. 2 is a side view that schematically shows the electricity storage module.

FIG. 3 is a perspective view that schematically shows a lithium ion battery.

FIG. 4 is a longitudinal cross section view that schematically shows the lithium ion battery.

FIG. 5 is an exploded view that schematically shows an electrode assembly.

FIG. 6 is a plane view that schematically shows one suitable aspect of a spacer (a breakable type spacer) disclosed herein.

FIG. 7 is a longitudinal cross section view that schematically shows a state of the one suitable aspect of the herein disclosed spacer (the breakable type spacer) before operation.

FIG. 8 is a longitudinal cross section view that schematically shows a state of the one suitable aspect of the herein disclosed spacer (the breakable type spacer) after operation.

FIG. 9 is a plane view that schematically shows one suitable aspect of the spacer (a fitting type convex part side spacer) disclosed herein.

FIG. 10 is a plane view that schematically shows the one suitable aspect of the herein disclosed spacer (a fitting type concave part side spacer).

FIG. 11 is a longitudinal cross section view that schematically shows a state of the one suitable aspect of the herein disclosed spacer (the fitting type spacer) before operation.

FIG. 12 is a longitudinal cross section view that schematically shows a state of the one suitable aspect of the herein disclosed spacer (the fitting type spacer) after operation.

FIG. 13 is a side view that schematically shows an electricity storage module in accordance with another embodiment disclosed herein.

FIG. 14 is an explanation view that is to explain a movement of the spacer of the electricity storage module in accordance with another herein disclosed embodiment.

FIG. 15 is a perspective view that schematically shows a pack case style electricity storage module disclosed herein.

### DESCRIPTION OF EMBODIMENTS

Below, an electricity storage module in the present disclosure would be explained. Incidentally, in the following accompanying drawings, the same numerals and signs are given to the members/parts providing the same effect. Further, the dimensional relation (such as length, width, and thickness) in each drawing does not reflect the actual dimensional relation. In the explanation described below, reference signs L, R, U, and D in drawings respectively represent left, right, up, and down of the electricity storage module and a later-described lithium ion secondary battery 1. In addition, it is defined as an up and down direction (a height direction Y), a left and right direction (a width direction X), and a front and rear direction (a column direction Z). However, these are merely directions for convenience sake of explanation, and are not to restrict a disposed aspect of the electricity storage module at all.

### Definition of Term

In the present description, a wording “electricity storage device” is a concept that semantically covers a device generating an electrical charge and discharge response by a movement of an electrical charge carrier between a pair of electrodes (a positive electrode and a negative electrode). In other words, the electricity storage device semantically covers a battery, such as secondary battery (for example, a lithium ion secondary battery, a nickel hydrogen battery, and a nickel cadmium battery), and a capacitor (a physical battery), such as lithium ion capacitor and electric double layer capacitor. Incidentally, below, while the lithium ion secondary battery being a typical one of the electricity storage device is used as an example, the present embodiment will be described. In addition, the wording “lithium ion secondary battery” in the present description represents an electricity storage device which uses a lithium ion as an electrical charge carrier and in which the electrical charge and discharge is repeatedly implemented due to a movement of the electrical charge according to the lithium ion between the positive electrode and the negative electrode.

In the present description, the wording “electricity storage module” represents a collection of electricity storage devices in which plural electricity storage devices are built. Additionally, in the present description, the wording “cell” or “single battery” is a term denoting each of the electricity storage devices electrically connected to each other in order to configure the electricity storage module.

When a numerical value range is described as “A to B (here, A and B are arbitrary values)” in the present description, it means “equal to or more than A and not more than B” and it semantically covers meanings “more than A and less than B”, “more than A and not more than B” and “equal to or more than A and less than B”.

### Electricity Storage Module 100

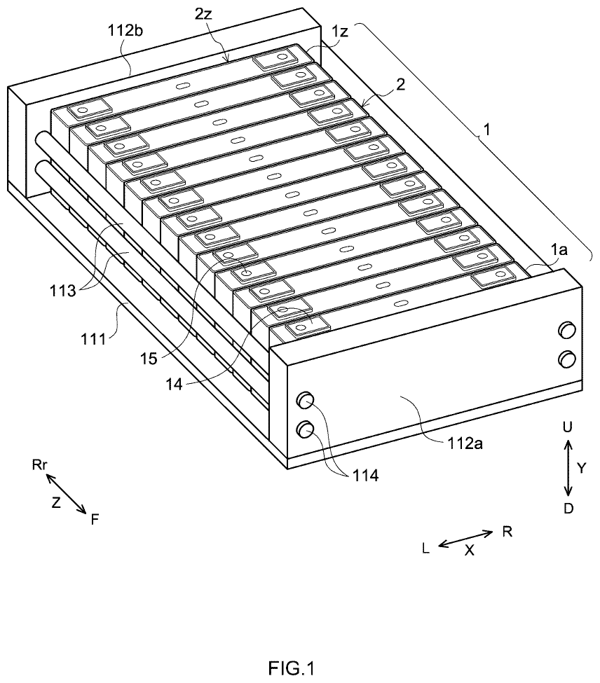

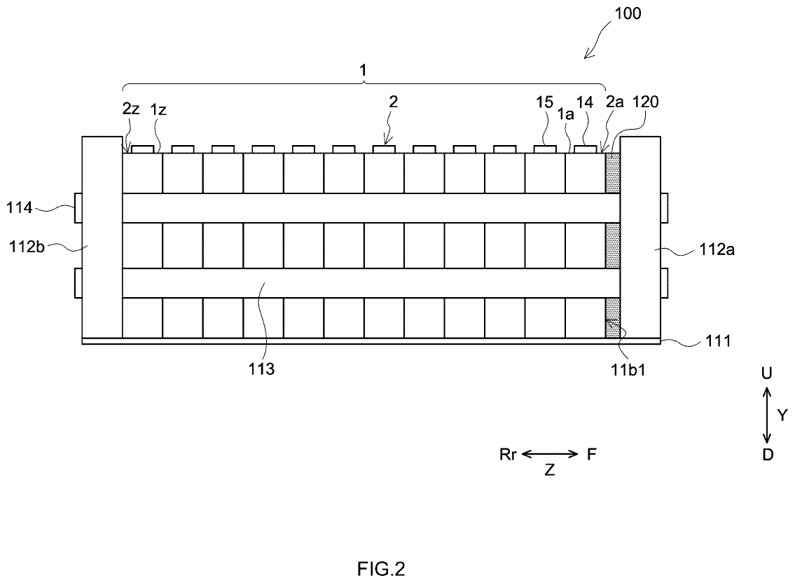

FIG. 1 is a perspective view that schematically shows an electricity storage module 100. FIG. 2 is a side view that schematically shows the electricity storage module 100. FIG. 2 is a view in which FIG. 1 is viewed from a different direction (left side surface (L direction) side).

The electricity storage module 100 includes, as shown in FIG. 1, plural electricity storage devices, a spacer 120, and a restriction member 110. In an example shown by FIG. 1, the electricity storage device is a lithium ion secondary battery 1, and might be suitably treated as the lithium ion secondary battery 1, below.

### Plural Electricity Storage Devices (Lithium Ion Secondary Batteries 1)

In this embodiment, as shown by FIG. 1 and FIG. 2, plural lithium ion secondary batteries 1 are arranged along a predetermined direction (in this embodiment, along the column direction Z). In FIG. 1, a near side in the column direction Z is defined as front (reference sign F), and a depth side is defined as rear (reference sign Rr). Regarding adjacent lithium ion secondary batteries 1, a wide width surface 11b1 and a wide width surface 11b2 are respectively opposed. In other words, the plural lithium ion secondary batteries 1 are arranged to make the wide width surfaces 11b1, 11b2 be opposed. By doing this, the plural lithium ion secondary batteries 1 are arranged in alternating directions so as to make a positive electrode outside terminal 14 and a negative electrode outside terminal 15 be aligned alternately. Incidentally, the positive electrode outside terminal 14 of one of the adjacent lithium ion secondary batteries 1 and the negative electrode outside terminal 15 of the other one of the adjacent lithium ion secondary batteries 1 are electrically connected to each other by a metal bus bar (not shown). However, it is not to restrict the arrangement of the lithium ion secondary batteries 1 and a connection method. The lithium ion secondary batteries 1 can be connected in series or in parallel.

### Electricity Storage Device: Lithium Ion Secondary Battery 1

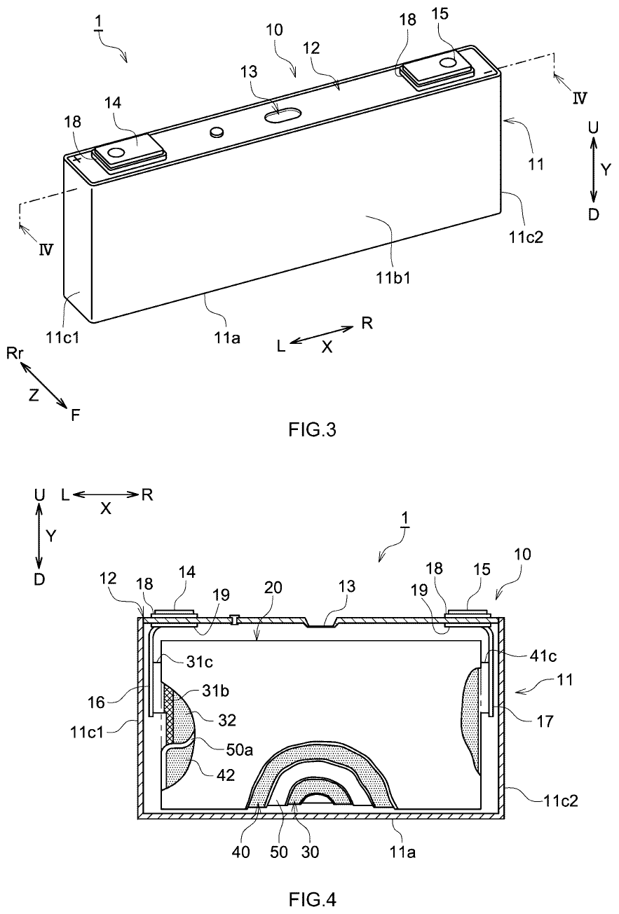

FIG. 3 is a perspective view that schematically shows the lithium ion secondary battery 1. FIG. 4 is a longitudinal cross section view that schematically shows the lithium ion secondary battery 1. FIG. 4 is a longitudinal cross section view that schematically shows the lithium ion secondary battery 1 along an IV-IV line of FIG. 3. Additionally, in FIG. 4, for clearly showing a configuration of an electrode assembly 20, a part of the electrode assembly 20 is transparently shown.

### Case 10

As shown by FIG. 3, in this embodiment, a shape of the case 10 is a rectangular parallelepiped shape, and a flat square shape. In addition, the case 10 includes a main body 11 that is configured to accommodate the electrode assembly 20 and an electrolytic solution (not shown)and includes a sealing plate 12 (a lid body) that is configured to seal an opening of the main body 11. The main body 11 and the sealing plate 12 are welded and sealed (hermetically sealed) by laser-welding, or the like. A material of the case 10 is not particularly restricted, as it is good if being the same as one conventionally used for this kind of electricity storage device. As one example, the material of the case 10 is a metal material being lightweight and having a good thermal conductivity, such as aluminum. However, it is possible to change a configuration of the case 10. For example, as the case, it is possible to use a laminate film having a flexibility.

In this embodiment, the main body 11 of the case 10 is configured with a rectangular and long bottom surface 11a, a pair of wide width surfaces 11b1, 11b2 extending from the bottom surface 11a and being opposed to each other, and a pair of narrow width surfaces 11c1, 11c2. Incidentally, in an explanation described below, for convenience sake, one wide width surface 11b1 among the pair of opposed wide width surfaces 11b1, 11b2 might be also referred to as “first surface” and the other wide width surface 11b2 might be also referred to as “second surface”, too.

In addition, the case 10 is provided with a safe valve 13 and a liquid injection hole (not shown in drawings). The safe valve 13 is a thin-walled valve that is set to release an internal pressure of the case 10 when the internal pressure is increased to a level being equal to or more than a predetermined level. The liquid injection hole is a hole configured to make the electrolytic solution be injected. The liquid injection hole becomes unnecessary after the liquid injection of the electrolytic solution, and thus can be sealed by the laser-welding, or the like. Alternatively, the liquid injection hole can be sealed by a plug being attached.

The positive electrode outside terminal 14 and the negative electrode outside terminal 15 for an outside connection are provided in a state of being exposed to an outside of the case 10. These outside terminals are electrically connected to the electrode assembly 20 accommodated in the case 10, via a positive electrode inside terminal 16 or a negative electrode inside terminal 17. The positive electrode outside terminal 14 and the negative electrode outside terminal 15 are made of metal. As the positive electrode outside terminal 14, for example, it is possible to use an aluminum, an alloy in which the aluminum is main, or the like. As the negative electrode outside terminal 15, for example, it is possible to use a copper, a copper alloy, or the like.

The positive electrode inside terminal 16 and the negative electrode inside terminal 17 are made of metal. As for the positive electrode inside terminal 16, from a perspective of enhancing a joint strength with the positive electrode tab 31c (or, a positive electrode active material layer non-formation part 31a), for example, it is possible to use aluminum, aluminum alloy, or the like. As the negative electrode inside terminal 17, from a perspective of enhancing a joint strength with the negative electrode tab 41c (or, a negative electrode active material layer non-formation part 41a), for example, it is possible to use copper, copper alloy, or the like.

In this embodiment, the positive electrode outside terminal 14 and the negative electrode outside terminal 15 are attached through a gasket 18 to the sealing plate 12. In addition, the positive electrode inside terminal 16 and the negative electrode inside terminal 17 are attached through an insulator 19 to a back surface (an inner side) of the sealing plate 12. As materials of the gasket 18 and the insulator 19, an insulation material can be used which is superior in a chemical resistance property and a weather resistance property.

### Electrolytic Solution

The case 10 is configured to accommodate the electrolytic solution. For example, the electrolytic solution is a liquid electrolyte that is in a liquid form at a room temperature (25° C.). As this electrolytic solution, it is possible to use a conventionally known nonaqueous electrolytic solution, without particular restriction. As for the nonaqueous electrolytic solution, carbonates are suitable.

### Electrode Assembly 20

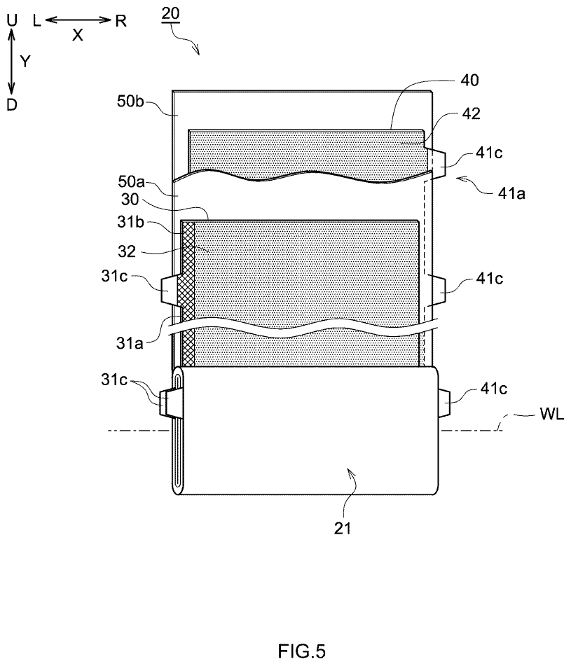

The case 10 is configured to accommodate the electrode assembly 20. The electrode assembly 20 includes a positive electrode 30 and a negative electrode 40. FIG. 5 is an exploded view that schematically shows the electrode assembly 20. In this embodiment, the electrode assembly 20 is a wound electrode assembly, in which the positive electrode 30 formed in a strip-like shape and the negative electrode 40 formed in a strip-like shape are stacked along a length direction via separators 50a, 50b formed in strip-like shapes, and which is then wound around a winding axis WL set in a width direction of the positive electrode 30. In this embodiment, the electrode assembly 20 includes a positive electrode tab 31c that is provided at one end in the winding axis direction. In addition, at a side of the other end in the winding axis direction, a negative electrode tab 41c is provided. In other words, the positive electrode tab 31c is provided at one of end parts of the electrode assembly 20 and the negative electrode tab 41c is provided at an end part in a direction, along the winding axis WL. Incidentally, the electrode assembly 20 is not restricted to the wound electrode assembly, and might be a laminate type electrode assembly in which the positive electrode and the negative electrode are alternately stacked via the separators. In addition, the laminate type electrode assembly might be formed to have a so-called Z-shape in which the strip-like shaped separators sandwich the positive electrode and the negative electrode and then they are folded and bent in a zig-zag shape.

### Positive Electrode 30

As shown in FIG. 5, the positive electrode 30 includes a positive electrode current collector foil 31 that is formed in a rectangular shape, and a positive electrode active material layer 32 that is formed on a surface of this positive electrode current collector foil 31. The positive electrode active material layer 32 can reversibly store and release the electrical charge carrier (for example, the lithium ion). In other words, the positive electrode active material layer 32 contains a positive electrode active material that can release the electrical charge carrier at an electrically charging time and can store the electrical charge carrier at an electrically discharging time. Incidentally, it is good for the positive electrode active material layer 32 to be formed on one surface or both surfaces (here, both surfaces) of the positive electrode current collector foil 31. In addition, the positive electrode 30 might include the positive electrode active material layer non-formation part 31a on which the positive electrode active material layer 32 is not formed and thus the positive electrode current collector foil 31 is exposed. The positive electrode active material layer non-formation part 31a is provided at one end of the electrode assembly 20. In this embodiment, at a border of the positive electrode active material layer 32, a positive electrode protective layer 31b is provided on the positive electrode current collector foil 31 (further particularly, on the positive electrode active material layer non-formation part 31a). The positive electrode protective layer 31b is a layer configured to protect the positive electrode active material layer non-formation part 31a, and can be a layer that contains an inorganic filler (for example, alumina, or the like).

As a material of the positive electrode current collector foil 31, it is possible to use a well known positive electrode current collector foil that is used on this kind of electricity storage device, and that is not particularly restricted. As the material of the positive electrode current collector foil 31, for example, it is possible to use an aluminum or an aluminum alloy. As the positive electrode active material of the positive electrode active material layer 32, it is possible to use a positive electrode active material used for the positive electrode of a general lithium ion secondary battery 1. As the lithium composite metal oxide, it is possible to use LiCoO₂, LiNiO₂, LiFeO₂, LiNiₓCo_{y}Mn_{1-x-y}O₂ (NCM), LiNi_{0.5}Mn_{1.5}O₄, LiNi_{0.8}Co_{0.15}Al_{0.005}O₂ (NCA), LiCrMO₄, LiMn₂O₄, LiFePO₄ (LFP), or the like. Incidentally, regarding these positive electrode active materials, 1 kind might be used alone, or 2 or more kinds might be combined and then used. Incidentally, the positive electrode active material layer 32 might contain various additives, such as binding agent (binder), conductive assistant agent, inorganic filler, and thickening agent.

### Negative Electrode 40

As shown in FIG. 5, the negative electrode 40 includes a negative electrode current collector foil 41 that is formed in a rectangular shape and a negative electrode active material layer 42 that is formed on a surface of the negative electrode current collector foil 41. The negative electrode active material layer 42 can reversibly store and release the electrical charge carrier (for example, the lithium ion). In other words, the negative electrode active material layer 42 contains a negative electrode active material that can store the electrical charge carrier at the electrically charging time and can release the electrical charge carrier at the electrically discharging time. Incidentally, it is good for the negative electrode active material layer 42 to be formed on one surface or both surfaces (here, both surfaces) of the negative electrode current collector foil 41. In addition, the negative electrode 40 might include the negative electrode active material layer non-formation part 41a on which the negative electrode active material layer 42 is not formed and thus the negative electrode current collector foil 41 is exposed. The negative electrode active material layer non-formation part 41a is provided at one end of the electrode assembly 20.

As a material of the negative electrode current collector foil 41, it is possible to use a well known negative electrode current collector foil that is used on this kind of electricity storage device, and that is not particularly restricted. As the material of the negative electrode current collector foil 41, for example, it is possible to use a copper or a copper alloy. As the negative electrode active material of the negative electrode active material layer 42, it is possible to use a negative electrode active material used for the negative electrode of the general lithium ion secondary battery. In particular, as the negative electrode active material, it is possible to use a carbon material, such as soft carbon (easily graphitized carbon), amorphous carbon material, graphite, hard carbon (hardly graphitized carbon), and carbon nanotube, a silicon chemical compound, or the like. Incidentally, regarding these negative electrode active materials, 1 kind might be used alone, or 2 or more kinds might be combined and then used. Incidentally, the negative electrode active material layer 42 might contain the various additives, such as binding agent (binder), conductive assistant agent, inorganic filler, and thickening agent.

### Separators 50a, 50b

The separators 50a, 50b of this embodiment are porous sheets that have insulating properties. However, it is good for a shape or a size of the separator 50a, 50b to be suitably decided in accordance with a design of the electricity storage device, and thus is not particularly restricted. Typically, since the separators 50a, 50b are used for establishing an insulation between the positive electrode 30 and the negative electrode 40, the sizes of the separators 50a, 50b are larger than the positive electrode 30 and the negative electrode 40. As a material of the separators 50a, 50b, it is possible to use a retail separator that is used for this kind of electricity storage device, and it is not particularly restricted. For example, as the material of the separators 50a, 50b, it is possible to suitably use a polyolefin, such as polyethylene and polypropylene, and a resin, such as polyester, cellulose, and polyamide.

### Restriction Member 110

The restriction member 110 is, as shown in FIG. 1 and FIG. 2, a member configured to restrict the plural lithium ion secondary batteries 1 (the electricity storage devices) and the spacer 120. The restriction member 110 is configured to restrict the plural lithium ion secondary batteries 1 in a direction along which the plural lithium ion secondary batteries 1 are arranged to make the wide width surfaces 11b1, 11b2 be opposed to each other (the column direction Z in this embodiment). In this embodiment, as shown by FIG. 1 and FIG. 2, the restriction member 110 includes a pair of end plates (a first end plate 112a and a second end plate 112b). The end plates are arranged at a starting point and an end point in the direction along which the plural lithium ion secondary batteries 1 are arranged to make the wide width surfaces 11b1, 11b2 be opposed to each other. Further particularly, the restriction member 110 includes the first end plate 112a that is arranged at a side of one end part of the arranged lithium ion secondary batteries 1 (in other words, a first end part 2a of the laminate body 2, a lithium ion secondary battery 1a at a front F side in this embodiment). In addition, the restriction member 110 includes the second end plate 112b that is arranged at a side of the other end part of the arranged lithium ion secondary batteries 1 (in other words, a second end part 2z of the laminate body 2, a lithium ion secondary battery 1z at a rear Rr side in this embodiment). Incidentally, the term “laminate body” denoting the electricity storage device in the present description means a collection of cells in which these plural cells are arranged along one direction.

The restriction member 110 further includes a side bar 113 and a bottom plate 111. In this embodiment, as shown by FIG. 1, the side bar 113 is bridged between the first end plate 112a and the second end plate 112b. In this restriction member 110, the pair of end plates (the first end plate 112a and the second end plate 112b) are connected by the side bar 113 and plural screws 114. However, the first end plate 112a, the second end plate 112b, and the side bar 113 can be connected by an adhesion agent, welding, or the like, too. The side bar 113 is configured to support the narrow width surfaces 11c1, 11c2 of the lithium ion secondary battery 1, in order to arrange the lithium ion secondary batteries 1 along the column direction Z. In addition, the bottom plate 111 is arranged to abut on the bottom surfaces 11a of the plural lithium ion secondary batteries 1.

Materials of the first end plate 112a, the second end plate 112b, the side bar 113, and the bottom plate 111 are not particularly restricted. These materials can be selected from metals, resins, or the like. In addition, the materials of respective members might be the same, or might be different from each other. From perspectives of a strength of the restriction member 110 and of applying a suitable load onto the lithium ion secondary battery 1 and the spacer 120, it is preferable that these materials are metals. In addition, shapes of the first end plate 112a, the second end plate 112b, the side bar 113, and the bottom plate 111 are not particularly restricted. For example, the side bar 113 also might be formed in a plate shape. In this embodiment, the first end plate 112a, the second end plate 112b, and the bottom plate 111 are rectangular, and have predetermined thicknesses (for example, thicknesses into which plural screws 114 can be driven).

Incidentally, in this embodiment, by the restriction member 110, the spacer 120 and the laminate body 2 are restricted in the direction (here, the column direction Z) along which the plural lithium ion secondary batteries 1 are arranged to make the wide width surfaces 11b1, 11b2 be opposed to each other. By doing this, the restriction member 110 is configured to be able to apply a predetermined load along the column direction Z onto the spacer 120 and onto the lithium ion secondary batteries 1. Incidentally, the restriction load applied by the restriction member 110 is not particularly restricted, insofar as an effect of the technique of the present disclosure is not significantly spoiled. Regarding the electricity storage device, such as lithium ion secondary battery, the volume can be expanded over time, for example, by the electrical charge and discharge being repeated. In an initial state (before the expansion) of the electricity storage device, if the restriction load is made to be too larger, an increase in the load caused by the expansion of the electricity storage device becomes significant, and thus the electrolytic solution tends to be easily pushed out from the electrode assembly. From the perspective as described above, an upper limit value of the initial restriction load is preferably equal to or less than 10 kN, further preferably equal to or less than 8 kN, or furthermore preferably equal to or less than 6 kN. In addition, if the initial restriction load is too smaller, a durability of the module is reduced (typically, it becomes easily affected by an external force, such as impact and vibration). In addition, a distance between the electrodes becomes larger, and thus a resistance value is increased. Therefore, a lower limit value of the initial restriction load is preferably equal to or more than 4 kN, further preferably equal to or more than 4.7 kN, or furthermore preferably equal to or more than 5 kN.

Anyway, the sealed type electricity storage device as described above tends to cause an expansion and contraction in response to the electrical charge and discharge, to have the inside swelling over time, and to have the case 10 swelling. Additionally, in a situation where the sealed type electricity storage device becomes larger and then an energy density is high, or the like, the case 10 further often tends to swell. Thus, on the electricity storage module including the electricity storage device as described above, there is a tendency that a restriction pressure is gradually increased. Therefore, the side surfaces of the plural electricity storage devices (further particularly, a flat surface 21 of the electrode assembly 20 in the electricity storage device) is strongly pressed. Then, the electrolytic solution impregnated into the electrode assembly 20 inside the electricity storage device is pushed away from a portion between the electrodes. By doing this, a liquid unevenness of the electrolytic solution inside the electricity storage device (typically, non-uniform of a concentration distribution of the electrical charge carrier (for example, the lithium ion)) can be generated.

Based on a knowledge described above, the present inventor proposes a new configuration for the electricity storage module. The herein disclosed electricity storage module 100 includes the spacer 120. In addition, the spacer 120 is arranged between the electricity storage device, arranged at the first end part 2a in the direction along which the wide width surfaces 11b1, 11b2 of the plural electricity storage devices are arranged to be opposed, and the restriction member 110. Regarding the spacer 120 described above, the thickness becomes smaller, when a load being larger than a predetermined load is applied along the direction in which the plural lithium ion secondary batteries 1 are arranged to make the wide width surfaces 11b1, 11b2 be opposed.

### Spacer 120

The spacer 120 is provided to abut on the lithium ion secondary battery 1. In this embodiment, the spacer 120 is arranged on a portion between the lithium ion secondary battery 1a at the first end part 2a side and the first end plate 112a. However, the arrangement of the spacer 120 is not restricted to this. The spacer 120 might be arranged on a portion between the lithium ion secondary battery 1z at the second end part 2z side and the second end plate 112b. In addition, the spacer 120 might be arranged on a portion between the lithium ion secondary batteries 1.

Incidentally, in a situation like the electricity storage module 100 where plural cells are arranged along one direction, the load tends to be concentrated on an end part in the direction along which the cells are aligned (here, the first end part 2a and/or the second end part 2z). This is caused by a matter that the thickness being increased due to the swells of respective cells is biased towards the either end part. In addition, there is a situation where not all cells swell uniformly and thus a degree of the swell (the thickness after the swell) is different on each cell. Even in that situation, by arranging the spacer 120 at the end part, the spacer 120 can absorb the swells of the plural cells. Therefore, preferably, the spacer 120 is arranged at the either end part (in other words, the first end part 2a and/or the second end part 2z of the laminate body 2) of the arranged plural lithium ion secondary batteries 1. In addition, arranging it at the end part is easier to perform the attachment than arranging it between cells. In this embodiment, as one suitable example for the arrangement of the spacer 120, it is provided between the lithium ion secondary battery 1a at the first end part 2a side and the first end plate 112a. By doing this, it becomes easier to regulate the directions of the loads to one direction (here, to the first end part 2a side). By doing this, the spacer 120 becomes easily absorbing the swells of the plural lithium ion secondary batteries 1, and thus setting an operating pressure becomes easier. Therefore, it is possible to make a dimensional change of the spacer 120 be stable.

A material of the herein disclosed spacer 120 is not particularly restricted, as it is enough to be one conventionally used for this kind of spacer (for example, an inter-cell separator, or the like). Typically, the material of the spacer 120 can be a metal or a resin. As a metal, it is possible to use an aluminum, an alloy whose main component is the aluminum, or the like. As the resin, it is possible to use a polyolefin resin, a polyethylene resin, an ethylene propylene rubber, or the like. Among them, from a perspective of suitably obtaining an effect of the technique of the present disclosure, the material of the spacer 120 is preferably the metal, or preferably in particular the aluminum or the alloy whose main component is the aluminum. In addition, from a perspective of the safety property, it is preferable that the spacer 120 has an insulating property. It is possible to use the resin material having the above described insulating property, and it is preferable that an insulation coating is performed on the metal material.

The spacer 120 is a rectangular plate-shaped member. In this embodiment, the spacer 120 is provided to be opposed to the first surface 11b1 of the lithium ion secondary battery 1a positioned at the first end part 2a side. The thickness of the spacer 120 is not particularly restricted, insofar as the effect of the technique of the present disclosure is exhibited. However, when the thickness of the spacer 120 is too larger, a volume energy efficiency of the electricity storage module 100 happens to be reduced. Thus, when a mean thickness of all lithium ion secondary batteries 1 contained in the electricity storage module 100 is treated as 100% under a state before the restriction is performed (before the load is applied), an upper limit value of the thickness of the spacer 120 is preferably equal to or less than 5%, further preferably equal to or less than 4.5%, or furthermore preferably equal to or less than 4%. Additionally, in a situation where the thickness of the spacer 120 is too smaller, the reduction in the restriction pressure becomes smaller when the thickness becomes smaller by the load being applied, the load being larger than a previously determined load. Therefore, a lower limit value of the thickness of the spacer 120 is preferably equal to or more than 1%, further preferably equal to or more than 1.2%, or furthermore preferably equal to or more than 1.5%.

Regarding the herein disclosed spacer 120, the dimension is changed in the direction (here, in the column direction Z) along which the plural electricity storage devices are arranged so as to make the wide width surfaces 11b1, 11b2 be opposed to each other. Further particularly, it is configured to make the thickness become smaller when the load being larger than the predetermined load is applied along the column direction Z. The predetermined load is not particularly restricted, insofar as the effect of the technique of the present disclosure is exhibited. The predetermined load can be suitably set in accordance with an object (for example, a purpose of the electricity storage module, or the like). When the load applied in the column direction Z is increased, there is a tendency that the electrolytic solution is pushed away from the electrode assembly 20. From a perspective described above, an upper limit value of the predetermined load is, for example, preferably equal to or less than 90 kN, further preferably equal to or less than 85 kN, or furthermore preferably equal to or less than 80 kN. In addition, the lower limit value is, for example, preferably equal to or more than 10 kN, further preferably equal to or more than 50 kN, or furthermore preferably equal to or more than 70 kN. Incidentally, as for the predetermined load, it is allowed, for example, to contain a little shift (for example, ±10%, ±5%, ±1%, or the like) due to human or mechanical error, or the like. In other words, regarding the term “predetermined load” in the present description, values being set as described above can be understood to be modified by a wording “substantially”, “about”, “approximately”, or the like.

In the embodiment described above, the electricity storage module 100 includes the plural lithium ion secondary batteries 1, the spacer 120, and the restriction member 110. The spacer 120 is arranged at the first end part 2a in the direction along which the wide width surfaces 11b1, 11b2 of the plural electricity storage devices are arranged to be opposed to each other. In addition, the spacer 120 is arranged at the portion between the lithium ion secondary battery 1 and the restriction member 110. The thickness of the spacer 120 becomes smaller, when the load being larger than the predetermined load is applied along the direction in which the wide width surfaces 11b1, 11b2 of the plural electricity storage devices are arranged so as to be opposed to each other. According to this spacer 120, it is possible to release the restriction and to suitably reduce the restriction pressure, when the restriction pressure of the electricity storage module is increased so as to reach the predetermined load. Thus, the restriction pressure of the electricity storage module 100 does not become too higher, and thus it is possible to decrease the electrolytic solution pushed away from the electrode assembly 20. By doing this, it is possible to suppress the liquid unevenness of the electrolytic solution inside the electricity storage device (typically, non-uniformity of a concentration distribution of the electrical charge carrier (for example, the lithium ion)). As a result, it is possible to suppress a metal (for example, a metal lithium) becoming the electrical charge carrier inside the electrode assembly from being precipitated, so as to inhibit a performance degradation (for example, a cycle capacity maintenance rate) of the electricity storage device. In addition, regarding the electricity storage module 100 of the present disclosure, a number of parts is small, and thus the volume energy density as for the module is high.

In the above described embodiment, the lithium ion secondary battery 1 includes the electrode assembly 20 and the polygonal case 10. The restriction member 110 includes the first end plate 112a that is arranged at the first end part 2a side in the direction along which the wide width surfaces 11b1, 11b2 of the plural electricity storage devices are arranged to be opposed to each other and includes the second end plate 112b that is arranged at the second end part 2z side positioned at a side opposite to the first end part 2a side. In addition, the restriction member 110 includes the side bar 113 that is bridged between the first end plate 112a and the second end plate 112b. By doing this, it becomes easy to arrange the lithium ion secondary batteries 1 along the column direction Z. As a result, it is possible to suitably exhibit the dimensional change in the spacer 120 of the present disclosure. Furthermore, it becomes easy to protect the lithium ion secondary battery 1 from the impact, the vibration, or the like, coming from the outside of the electricity storage module 100.

Incidentally, the thickness of the spacer 120 after the thickness becomes smaller (in other words, after the dimension is changed) is not particularly restricted, insofar as the effect of the technique of the present disclosure is exhibited. However, from a perspective of suitably obtaining the effect described above, it is preferable that the spacer 120 is formed to make the thickness be reduced according to a number of the cells (here, the lithium ion secondary batteries 1). Regarding the thickness of the spacer 120, it is preferable that the thickness of the spacer 120 becomes smaller by an approximate [(a number of the cells arranged in the predetermined direction)×0.5 to 2.0] mm when it has reached the predetermined load. In addition, a thickness of the spacer 120 becomes smaller further preferably by an approximate [(the number of cells arranged in the predetermined direction)×0.5 to 1.5] mm, or furthermore preferably by an approximate [(the number of the cells arranged in the predetermined direction)×0.5 to 1.0] mm. By doing this, it is possible to efficiently release the restriction pressure.

### Suitable Example of Spacer

A suitable example of the spacer 120 as described above would be further particularly explained, below. Incidentally, as described above, according to the present disclosure, the spacer 120 used for the electricity storage module is provided, while the spacer 120 is arranged between the restriction member 110 and/or electricity storage device and the electricity storage device and the thickness becomes smaller when the load being larger than the predetermined load is applied along the predetermined direction. Here, the predetermined direction is the same as the direction in which the wide width surfaces 11b1, 11b2 of the plural lithium ion secondary batteries 1 are arranged to be opposed to each other.

### Example 1: Breakable Type Spacer 220

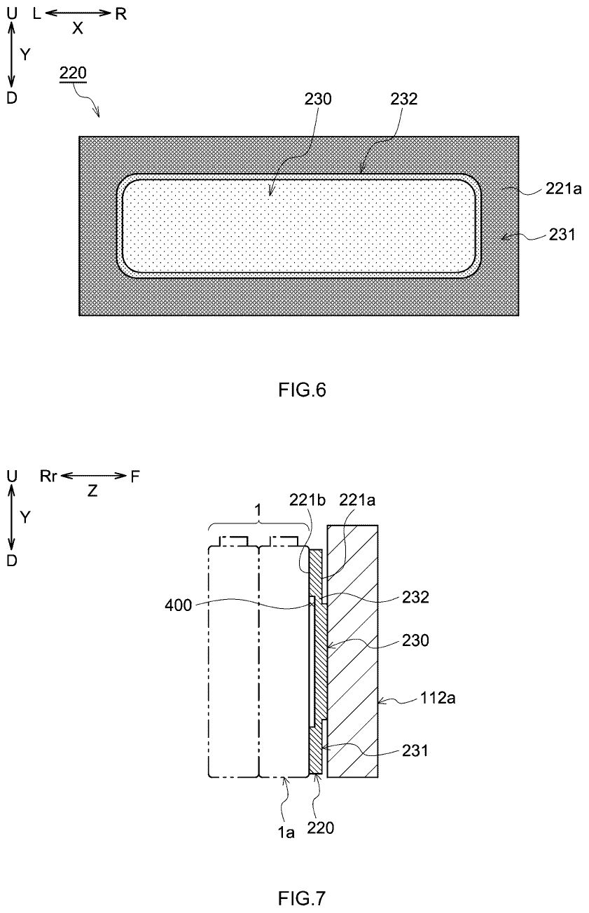

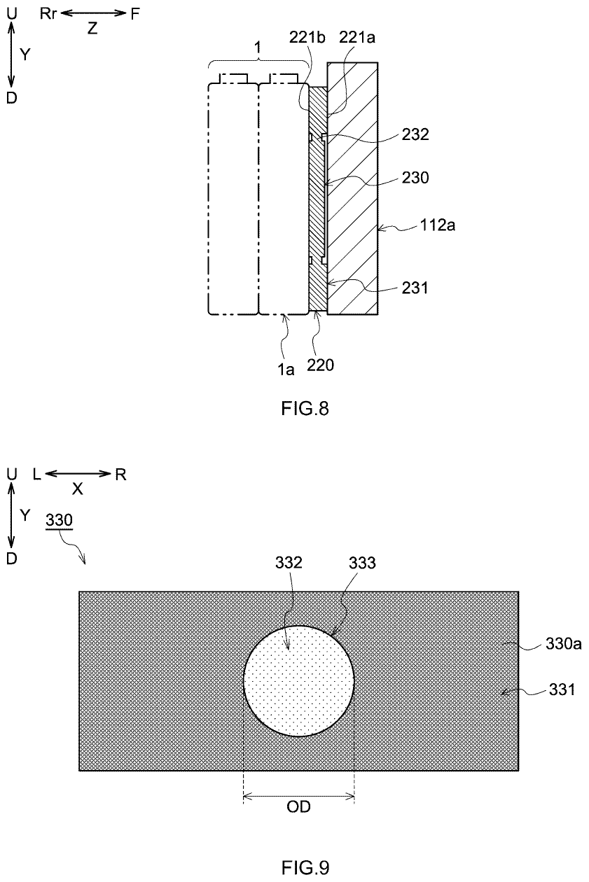

As a suitable example of the spacer 120 described above, it is possible to use, for example, one shown in FIG. 6 to FIG. 8. FIG. 6 is a plane view that schematically shows one suitable aspect (a breakable type spacer 220) of the herein disclosed spacer 120. FIG. 7 is a longitudinal cross section view that schematically shows a before-operation state of the one suitable aspect of the herein disclosed spacer 120 (the breakable type spacer 220). FIG. 8 is a longitudinal cross section view that schematically shows an after-operation state of the one suitable aspect of the herein disclosed spacer 120 (the breakable type spacer 220). In this example, the breakable type spacer 220 includes a first surface 221a (in this example, a right surface) and a second surface 221b that is a wrong surface with respect to the first surface 221a. FIG. 6 is a plane view in which the breakable type spacer 220 is viewed from the first surface 221a side. In FIG. 7 and FIG. 8, the restricted lithium ion secondary battery 1a and breakable type spacer 220 are viewed from a direction (here, the width direction X) orthogonal to the column direction Z. FIG. 8 shows the breakable type spacer 220 in a state where the load being larger than the predetermined load is applied to the breakable type spacer 220 of FIG. 7 along the column direction Z and then the thickness becomes smaller.

As shown in FIG. 6, the breakable type spacer 220 includes a convex part 230, an outer edge part 231, and a joint part 232. The convex part 230 is an area protruding toward a near side of FIG. 6 from the outer edge part 231. In addition, here, the convex part 230 is an area protruding toward the opposed first end plate 112a in the column direction Z from the outer edge part 231. As shown by FIG. 7, in this embodiment, the convex part 230 is restricted by the restriction member 110 so as to abut on the first end plate 112a. In addition, the outer edge part 231 is an area surrounding the convex part 230. The outer edge part 231 is restricted by the restriction member 110 so as to abut on the wide width surface 11b1 of the lithium ion secondary battery 1a. However, a direction of the breakable type spacer 220 is not restricted to this. The convex part 230 might be configured to abut on the lithium ion secondary battery 1a and the outer edge part 231 might be configured to abut on the first end plate 112a. In other words, the first surface 221a of the breakable type spacer 220 might be configured to be opposed to the first end plate 112a and the second surface 221b might be configured to be opposed to the wide width surface 11b1 of the lithium ion secondary battery 1a. In addition, the second surface 221b of the breakable type spacer 220 might be configured to be opposed to the first end plate 112a and the first surface 221a might be configured to be opposed to the wide width surface 11b1 of the lithium ion secondary battery 1a. The joint part 232 is an area configured to connect the convex part 230 and the outer edge part 231. A thickness of the joint part 232 can be typically formed in a thinner walled shape than a thickness of the convex part 230 or the outer edge part 231. In addition, the thicknesses of the convex part 230 and the outer edge part 231 might be the same, or might be different from each other.

Movement of the above described breakable type spacer 220 would be described. As shown in FIG. 7, before the swell of the lithium ion secondary battery 1, the convex part 230 of the breakable type spacer 220 is configured to abut on the first end plate 112a. In addition, the outer edge part 231 of the breakable type spacer 220 is configured to abut on the wide width surface 11b1 of the lithium ion secondary battery 1a. In this example, between the second surface 221b side of the convex part 230 and the wide width surface 11b1 of the lithium ion secondary battery 1a, there is a gap 400. In addition, there is a gap between the first surface 221a side of the outer edge part 231 and the first end plate 112a, too. When the load being larger than the predetermined load is applied along the column direction Z (the direction in which the lithium ion secondary batteries 1 are arranged), the joint part 232 is broken. Further particularly, if the lithium ion secondary batteries 1 gradually swell, the outer edge part 231 abutting on the lithium ion secondary battery 1a happens to be pushed toward the F direction. In addition, the first end plate 112a is fixed as the restriction member 110. Thus, the convex part 230 abutting on the first end plate 112a happens to be pushed back toward the Rr direction. By doing this, the joint part 232 is sheared and destroyed. After the joint part 232 is broken, the convex part 230 being separated from the outer edge part 231 is pushed into the gap 400 between the second surface 221 b side of the convex part 230 and the wide width surface 11b1 of the lithium ion secondary battery 1a. As shown in FIG. 8, the thickness of the breakable type spacer 220 is reduced by a pushed-into amount of the convex part 230. Incidentally, in this example, the outer edge part 231 is configured to move to the F direction and then to abut on the first end plate 112a.

The above described breakable type spacer 220 includes the convex part 230 protruding in the direction along which the plural lithium ion secondary batteries 1 are arranged to make the wide width surfaces 11b1, 11b2 be opposed to each other and includes the outer edge part 231 surrounding the convex part. In addition, between the convex part 230 and the outer edge part 231, the joint part 232 is provided. This joint part 232 is broken when the load being larger than the predetermined load is applied. By doing this, the thickness of the breakable type spacer 220 becomes smaller. According to the breakable type spacer 220 as described above, it is possible to configure with 1 member, so as to implement an advantage that a number of the members is small.

Regarding the breakable type spacer 220 described above, the load by which the joint part 232 is broken (in other words, the load by which the thickness of the breakable type spacer 220 becomes smaller) can be typically adjusted by changing the thickness of the joint part 232 (in other words, the thickness of the portion to be broken). For example, if the thickness of the joint part 232 is made to be smaller, the load required for making the joint part 232 be broken (in other words, making the thickness of the breakable type spacer 220 become smaller) is reduced more. In addition, if the thickness of the joint part 232 is made to be larger, the load required for making the joint part 232 be broken is increased more. The thickness of the joint part 232 described above can be suitably set by a person skilled in the art who performs a preliminary test, or the like. For example, by forming the breakable type spacer 220 so as to make a thickness of the joint part 232 be equal to or more than 0.8 mm and not more than 1.6 mm, it is possible to set the predetermined load being 4 kN to 80 kN. In addition, by forming the breakable type spacer 220 so as to make the thickness of the joint part 232 be equal to or more than 1.1 mm and not more than 2.0 mm, it is possible to set the predetermined load being 70 kN to 85 kN. Further preferably, by forming the breakable type spacer 220 so as to make the thickness of the joint part 232 be equal to or more than 1.5 mm and not more than 3.0 mm, it is possible to set the predetermined load being 75 kN to 120 kN. Incidentally, the breakable type spacer 220 can be easily manufactured, for example, by performing a pressing process on a metal plate material so as to form the convex part, or the like.

### Example 2: Fitting Type Spacer 320

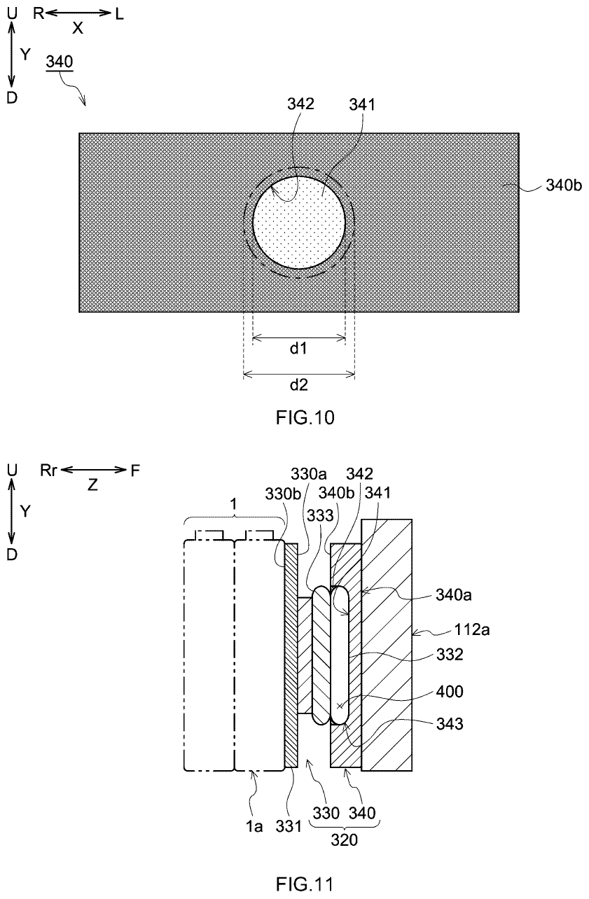

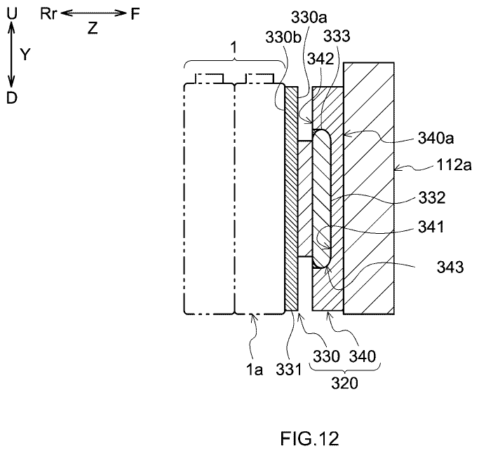

As another suitable example of the spacer 120 described above, for example, it is possible to use one shown in FIG. 9 to FIG. 12, too. In this example, the fitting type spacer 320 includes a convex part side spacer 330 and a concave part side spacer 340. FIG. 9 is a plane view that schematically shows one suitable aspect of the herein disclosed spacer 120 (a fitting-type convex part side spacer 330). In this example, the convex part side spacer 330 includes a first surface 330a (the right surface) and a second surface 330b being a wrong surface with respect to the first surface 330a. FIG. 9 is a plane view in which the convex part side spacer 330 is viewed from the first surface 330a side. In addition, FIG. 10 is a plane view that schematically shows one suitable aspect of the herein disclosed spacer 120 (a fitting-type concave part side spacer 340). In this example, the concave part side spacer 340 includes the first surface 340a (the right surface) and the second surface 340b being the wrong surface with respect to the first surface 340a. FIG. 10 is a plane view in which the concave part side spacer 340 is viewed from the second surface 340b side. FIG. 11 is a longitudinal cross section view that schematically shows the before-operation state of the one suitable aspect of the herein disclosed spacer 120 (the fitting type spacer 320). In addition, FIG. 12 is a longitudinal cross section view that schematically shows the after-operation state of the one suitable aspect of the herein disclosed spacer (the fitting type spacer 320). In FIG. 11 and FIG. 12, the states are shown in which the restricted lithium ion secondary battery 1a and the fitting type spacer 320 are viewed from the direction (here, the width direction X) orthogonal to the column direction Z. In FIG. 11, the state is shown in which the fitting type spacer 320 (the convex part side spacer 330 and the concave part side spacer 340) is not fitted, yet. In FIG. 12, the fitting type spacer 320 is shown under the state in which the load being larger than the predetermined load has been applied to the fitting type spacer 320 of FIG. 11 along the column direction Z and whose thickness has become smaller (in other words, under a fitted state).

The convex part side spacer 330 is a spacer including the convex part 332 that is configured to protrude toward the direction in which the plural lithium ion secondary batteries 1 are arranged so as to make the wide width surfaces 11b1, 11b2 be opposed to each other. As shown by FIG. 11 and FIG. 12, in this example, the convex part side spacer 330 includes a basal part 331, and a convex part 332 extending from this basal part 331. The basal part 331 is a rectangular plate-shaped member. The convex part 332 is a projection that is formed in a column shape and that is configured to protrude from the basal part 331. In addition, a tip end of the convex part 332 is provided with an overhanging part 333 that is configured to overhang in a direction orthogonal to the direction in which the plural lithium ion secondary batteries 1 are arranged so as to make the wide width surfaces 11b1, 11b2 be opposed to each other. A shape of this overhanging part 333 is not particularly restricted, insofar as the effect of the technique of the present disclosure is not significantly spoiled. As shown by FIG. 11 and FIG. 12, in this example, the overhanging part 333 is formed in a round head shape. By doing this, the concave part side spacer 340 is introduced along a curve line at a corner of the overhanging part 333, and thus it is possible to perform fitting smoothly.

The concave part side spacer 340 is a spacer that includes the concave part 341 configured to receive the convex part 332. The concave part 341 is a hollow that is provided on an opposed surface (in this example, the second surface 340b) opposed to the convex part so as to fit the convex part 332. Regarding this example, the concave part 341 is formed in a large hollow column shape whose inner diameter is larger than a diameter of the overhanging part 333, in order to fit the convex part 332 and the overhanging part 333 protruding outwardly from a side surface of the convex part 332. In addition, an entrance of the concave part 341 is provided with a caulking claw part 342 along an inner periphery. This caulking claw part 342 is a rib configured to overhang from the inner periphery surface 343 of the concave part 341 toward the center. In this example, the caulking claw part 342 is provided continuously along the inner periphery surface 343 of the concave part 341. However, the caulking claw part might be provided intermittently. As shown in FIG. 11 and FIG. 12, an inner diameter d1 of the caulking claw part 342 is provided to be narrower than an inner diameter d2 of the inner periphery surface 343 (a double wavy line of FIG. 11 represents the inner periphery surface 343 of the concave part 341). Incidentally, the inner diameter d2 of the inner periphery surface 343 is provided to be larger than a maximum outer diameter OD of the convex part side spacer 330, in order to make the overhanging part 333 be put into. By doing this, the fit overhanging part 333 becomes hard to come off, and thus it is possible to make it become stronger against the external force, such as impact and vibration.

Fitting movement of the above described fitting type spacer 320 would be explained. As shown by FIG. 11, in this example, the first surface 330a of the convex part side spacer 330 is arranged to be opposed to the second surface 340b of the concave part side spacer 340 along the direction (the column direction Z) in which the plural lithium ion secondary batteries 1 are arranged so as to make the wide width surfaces 11b1, 11b2 be opposed to each other. Before the swells of the lithium ion secondary batteries 1, the overhanging part 333 of the convex part side spacer 330 is restricted in a state of being pressed against the caulking claw part 342 of the concave part side spacer 340. Incidentally, in this state, the convex part side spacer 330 and the concave part side spacer 340 are not connected in a fitting manner, yet. Thus, between the convex part 332 of the convex part side spacer 330 and the concave part 341 of the concave part side spacer, there is the gap 400 into which the convex part 332 can be pushed. When the lithium ion secondary battery 1 swells and the load being larger than the predetermined load is applied, the convex part side spacer 330 is pushed into along the column direction Z. As shown in FIG. 12, after the swell of the lithium ion secondary battery 1, the convex part side spacer 330 and the concave part side spacer 340 are connected in the fitting manner. At that time, by the amount of the convex part 332 pushed into the gap of the concave part 341, the distance between the convex part side spacer 330 and the concave part side spacer 340 becomes closer, and thus the thickness of the spacer is reduced.

The above described fitting type spacer 320 includes the convex part 332 configured to protrude along the direction in which the plural lithium ion secondary batteries 1 are arranged so as to make the wide width surfaces 11b1, 11b2 be opposed to each other, includes the concave part 341 being provided on an opposed surface being opposed to the convex part, and includes the caulking claw part 342 formed at the entrance of the concave part 341 in a state of being opposed to the convex part 332. According to the configuration described above, when the predetermined load is applied, the convex part 332 fits into the concave part 341 and therefore the thickness of the spacer becomes smaller. Regarding the fitting type spacer 320 as described above, if it is activated once, the distance between the convex part 332 and the concave part 341 can become instantly shorter. Therefore, it has an advantage of being easily detected on a management system.

Regarding the fitting type spacer 320 described above, the load for fitting (in other words, the load for making the thickness of the fitting type spacer 320 be smaller) can be, typically, adjusted by changing a difference (OD−d2) between the maximum outer diameter OD of the overhanging part 333 and the inner diameter d2 of the caulking claw part 342 (the inner diameter of the entrance of the concave part 341, in other words, an opening part of the concave part 341 made to be narrow by the caulking claw part 342). For example, if the maximum outer diameter OD of the overhanging part 333 is made to be smaller (and/or the inner diameter d2 of the caulking claw part 342 is made to be larger), the difference of the fitting part becomes smaller and thus the load required for fitting is decreased. In addition, if the maximum outer diameter OD of the overhanging part 333 is made to be larger (and/or the inner diameter d2 of the caulking claw part 342 is made to be smaller), the difference of the fitting part becomes larger and thus the load required for fitting is increased. The difference of the fitting part described above can be suitably set by a person skilled in the art who performs a preliminary test, or the like. For example, by forming the fitting type spacer 320 so as to make the difference of the fitting part be equal to or more than 0.1 mm and not more than 0.6 mm, it is possible to set the predetermined load being 4 kN to 30 kN. In addition, by forming the fitting type spacer 320 so as to make the difference of the fitting part be equal to or more than 0.15 mm and not more than 0.8 mm, it is possible to set the predetermined load being 6 kN to 50 kN. Further preferably, by forming the fitting type spacer 320 so as to make the difference of the fitting part be equal to or more than 0.3 mm and not more than 1 mm, it is possible to set the predetermined load being 15 kN to 80 kN. Incidentally, the fitting type spacer 320 can be easily manufactured, for example, by performing a cutting process on a metal plate material to form the convex part and the concave part, or the like.

Above, the preferred embodiments of the present disclosure have been explained on a basis of drawings. However, these descriptions are not to be restriction matters, and various modifications can be performed, of course.

### Another Embodiment

Below, another embodiment will be described in which the herein disclosed electricity storage module is used. Incidentally, it is not intended to make the present disclosure be restricted into the following descriptions.

### Electricity Storage Module Including Plural Spacers

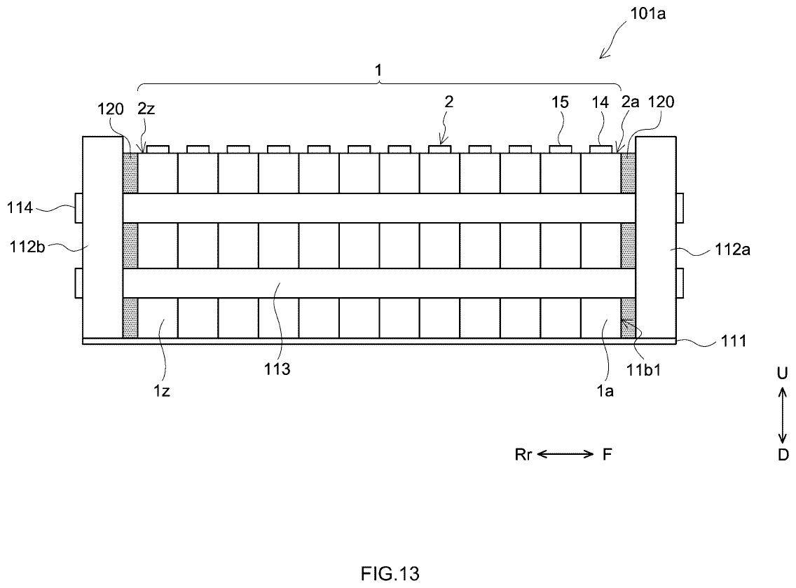

As another suitable example of the herein disclosed electricity storage module, it is possible to include plural spacers 120. FIG. 13 is a side view that schematically shows an electricity storage module 101a in accordance with another embodiment disclosed herein. As shown in FIG. 13, here, the spacers 120 are arranged at both ends (the first end part 2a and the second end part 2z of the laminate body 2) of the aligned plural lithium ion secondary batteries 1. In other words, regarding this example, the spacer 120 is provided between the lithium ion secondary battery 1a at the first end part 2a side of the laminate body 2 and the first end plate 112a. Further, it is provided between the lithium ion secondary battery 1z at the second end part 2z side and the second end plate 112b, too. By doing this, if the load being larger than the predetermined load is applied along the column direction Z, it is possible to make the thickness in the column direction Z be further smaller. As an effect for the above matter, it is possible by increasing the reduction in the restriction pressure to further surely suppress the electrolytic solution from being pushed out from the electrode assembly 20.

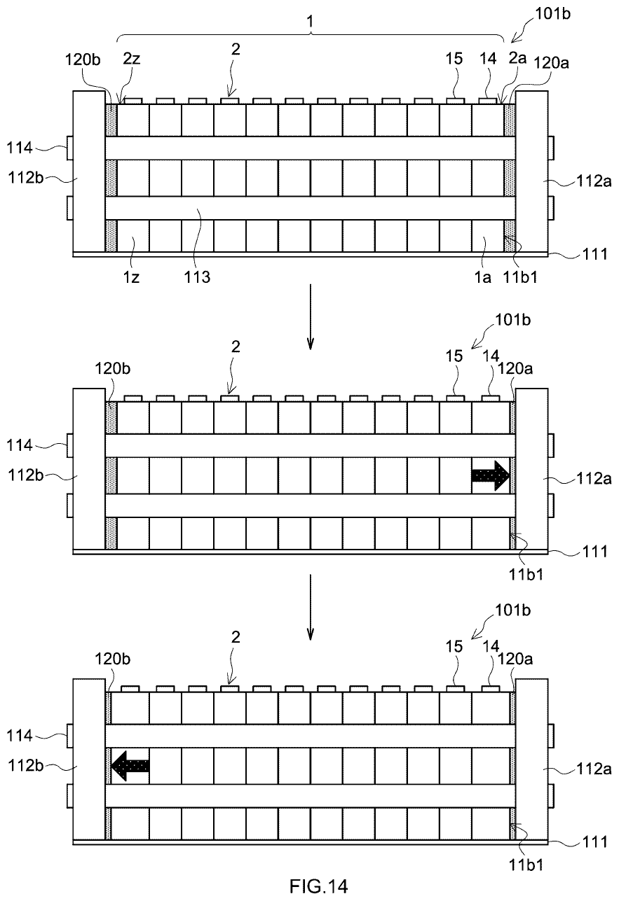

As a furthermore preferable example, it is possible to activate the spacers at the both ends, step by step. FIG. 14 is an explanation view that is to explain movements of a first spacer 120a and a second spacer 120b of an electricity storage module 101b in accordance with another embodiment disclosed herein. This electricity storage module 100 includes the first spacer 120a provided between the electricity storage device at the first end part 2a side (here, the lithium ion secondary battery 1a) and the first end plate 112a, and includes the second spacer 120b provided between the electricity storage device at the second end part 2z side (here, the lithium ion secondary battery 1z) and the second end plate 112b. Here, regarding the first spacer 120a, the thickness is made to become smaller when the load being larger than the predetermined load is applied along the direction (here, the column direction Z) in which the lithium ion secondary batteries 1 are arranged to make the wide width surfaces 11b1, 11b2 be opposed to each other. Then, the second spacer 120b is configured to have the thickness becoming smaller when the load being larger than the load for making the thickness of the first spacer 120a become smaller is applied along the column direction Z. As shown in FIG. 14, due to a prompt electrical charge and discharge, or the like, the plural electricity storage devices (here, the lithium ion secondary batteries 1) gradually swell along the column direction Z. By doing this, the first spacer 120a and the second spacer 120b are pressed along the column direction Z. In this example, at first, when the larger load over the predetermined load (for example, 4 kN to 80 kN) is applied, the thickness of the first spacer 120a becomes smaller. Next, when the load (for example, 15 kN to 80 kN) being larger than the load for making the thickness of the first spacer 120a be smaller is applied, the thickness of the second spacer 120b becomes smaller. By doing this, it is possible to further surely suppress the electrolytic solution from being pushed out from the electrode assembly 20. In addition, it is possible to suppress the drastic swell of the electricity storage device.

### Pack Case Style Electricity Storage Module

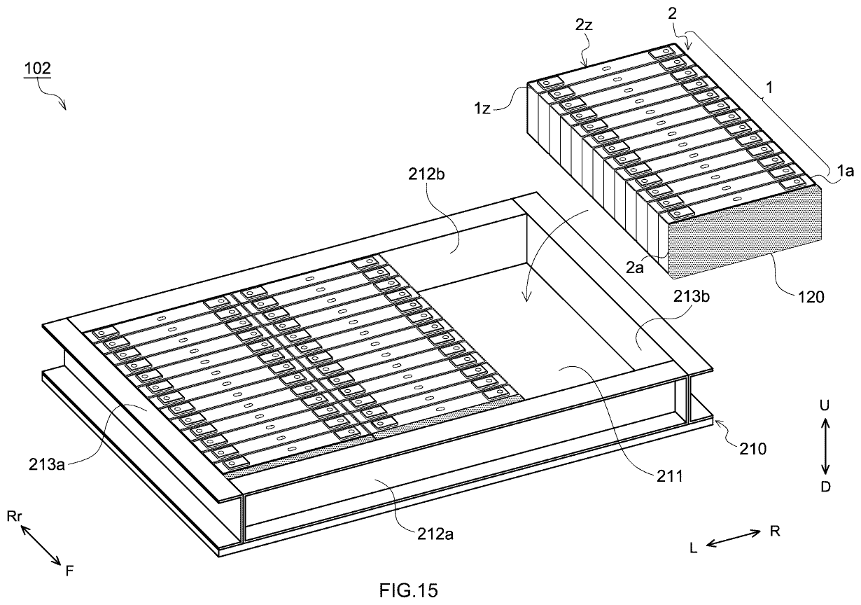

As one suitable embodiment of the herein disclosed electricity storage module, for example, it is possible to use pack style one shown in FIG. 14. FIG. 15 is a perspective view that schematically shows a herein disclosed pack case style electricity storage module 102. FIG. 15 shows a partially decomposed state, for clearly showing a configuration of the pack case style electricity storage module 102. As shown in FIG. 14, the plural electricity storage devices (here, the lithium ion secondary batteries 1) are arranged in the direction (here, the column direction Z) along which the wide width surfaces 11b1, 11b2 are arranged to be opposed to each other. The pack case style electricity storage module 102 is configured to accommodate the plural lithium ion secondary batteries 1 at an inside of the restriction member 110 (in this example, a pack case 210).

As shown in FIG. 15, the restriction member 110 might be, for example, the pack case 210. This pack case 210 includes an upper wall (not shown), a bottom wall 211, a first side wall 212a, a second side wall 212b, a third side wall 213a, and a fourth side wall 213b. Here, the first side wall 212a and the second side wall 212b are opposed to each other. The third side wall 213a and the fourth side wall 213b are opposed to each other. At the internal space of the pack case 210, the laminate body 2 is accommodated in the which plural lithium ion secondary batteries 1 are arranged along the column direction Z. Incidentally, along the width direction X orthogonal to the column direction Z, plural laminate bodies 2 (having 3 rows in FIG. 15, but the present disclosure is not restricted to this) are arranged. The first side wall 212a and the second side wall 212b extending along the width direction X can directly support the laminate body 2.

Plural electricity storage devices (the laminate bodies 2) include a first end part 2a that is one of end parts in the direction along which the plural lithium ion secondary batteries 1 are arranged to make the wide width surfaces 11b1, 11b2 be opposed to each other and include a second end part 2b at a side opposite to the first end part 2a. Here, between the lithium ion secondary battery 1a at the first end part 2a side in the column direction Z of each laminate body 2 and the restriction member 110 (the first side wall 212a of the pack case 210), the spacer 120 is arranged. This spacer 120 has the thickness becoming smaller when the load being larger than the predetermined load is applied along the column direction Z.

In the above described pack case style electricity storage module 102, by the side wall of the pack case 210 (here, the first side wall 212a), the plural lithium ion secondary batteries 1 (the laminate bodies 2) are supported via the spacer 120. According to the configuration described above, when the lithium ion secondary battery 1 of the laminate body 2 swells, the thickness of the spacer 120 becomes smaller. By doing this, it is possible to reduce the restriction pressure of the row.

Incidentally, this pack case style electricity storage module 102 has a so-called Cell-to-Pack structure, consisted by directly accommodating the plural electricity storage devices. According to the Cell-to-Pack structure described above, it is possible to reduce a number of the restriction members, and thus it is possible to enhance a volume energy efficiency as for the module. Incidentally, it might have a Cell-Module-Pack structure in which the electricity storage module 100 containing the previously described plural electricity storage devices is accommodated at an inside of the pack case 210.

### Use of Electricity Storage Module

The number of the electricity storage devices contained in the herein disclosed electricity storage module is not particularly restricted. The number of the electricity storage devices can be suitably decided according to a use purpose of the electricity storage module. As an example of the number of the electricity storage devices, it is possible, for example, to be equal to or more than 10, to be equal to or more than 20, or to be equal to or more than 30.

The herein disclosed electricity storage module can be used for various purposes. However, especially in a situation of high capacity (for example, a energy density of the cell is equal to or more than 500 Wh/L), the swell of the case tends to be caused easily depending on the prompt electrical charge and discharge cycle, and thus it is possible to suitably use the technique of the present disclosure. As a purpose for which the above described electricity storage module is required, for example, it is possible to be a power source (a driving power supply) for a motor mounted on a vehicle, such as passenger car and truck, or the like. In addition, a type of the vehicle is not particularly restricted, but, for example, it is possible to be a plug-in hybrid electric vehicle (PHEV), a hybrid electric vehicle (HEV), a battery electric vehicle (BEV), or the like.

In the technology disclosed herein, each component or each process referred to herein may be omitted or combined as appropriate, to the extent that no particular problems arise. This specification also includes the disclosures set forth in the following respective items.
Item 1: An electricity storage module, comprising: plural electricity storage devices; a restriction member; and a spacer, wherein the plural electricity storage devices have a pair of opposed wide width surfaces, the wide width surfaces are arranged to be opposed to each other, the restriction member is configured to restrict the plural electricity storage devices in a direction along which the plural electricity storage devices are arranged so as to make the wide width surfaces be opposed to each other, the spacer is arranged between an electricity storage device arranged at a first end part in the arranged direction among the plural devices and the restriction member, and a thickness of the spacer becomes smaller when a load being larger than a predetermined load is applied along the arranged direction.
Item 2: The electricity storage module according to item 1, wherein the electricity storage device comprises: an electrode assembly; and a square-shaped case that is configured to accommodate the electrode assembly, the restriction member comprises: a first end plate that is arranged at the first end part in the arranged direction among the plural electricity storage devices; a second end plate that is arranged at a second end part side positioned at a side opposite to a side of the first end part; and a side bar that is bridged between the first end plate and the second end plate, and the spacer is provided between the first end plate and a wide width surface of an electricity storage device at the side of the first end part.
Item 3: The electricity storage module according to item 1 or 2, wherein the predetermined load is equal to or more than 4 kN and not more than 80 kN.
Item 4: The electricity storage module according any one of items 1 to 3, wherein the spacer is rectangular, the spacer comprises: a convex part that is configured to protrude in the arranged direction; an outer edge part that is configured to surround the convex part; and a joint part that is configured to couple the convex part and the outer edge part, the joint part is formed in a thin-walled shape which is thinner than a thickness of the convex part or the outer edge part, and when the load being larger than the predetermined load is applied along the arranged direction, the joint part is broken and thus a thickness becomes smaller.
Item 5: The electricity storage module according any one of items 1 to 4, wherein the spacer comprises: a convex part that is configured to protrude in the arranged direction; a concave part that is provided on an opposed surface being opposed to the convex part; and a caulking claw part that is opposed to the convex part and that is formed at an entrance of the concave part, the convex part is arranged under a state of coming into contact with the caulking claw part so as to form a gap between the convex part and the concave part, and when the load being larger than the predetermined load is applied along the arranged direction, the convex part and the concave part fit to each other and thus a thickness becomes smaller.
Item 6: The electricity storage module according to any one of claims 1 to 6, wherein the spacer is provided between an electricity storage device at a side of the second end part and the second end plate, too.

1. An electricity storage module, comprising:
plural electricity storage devices;
a restriction member; and
a spacer, wherein
the plural electricity storage devices have a pair of opposed wide width surfaces,
the wide width surfaces are arranged to be opposed to each other,
the restriction member is configured to restrict the plural electricity storage devices in a direction along which the plural electricity storage devices are arranged so as to make the wide width surfaces be opposed to each other,
the spacer is arranged between an electricity storage device arranged at a first end part in the arranged direction among the plural devices and the restriction member, and
a thickness of the spacer becomes smaller when a load being larger than a predetermined load is applied along the arranged direction.

2. The electricity storage module according to claim 1, wherein
the electricity storage device comprises: an electrode assembly; and a square-shaped case that is configured to accommodate the electrode assembly,
the restriction member comprises:
a first end plate that is arranged at the first end part in the arranged direction among the plural electricity storage devices;
a second end plate that is arranged at a second end part side positioned at a side opposite to a side of the first end part; and
a side bar that is bridged between the first end plate and the second end plate, and
the spacer is provided between the first end plate and a wide width surface of an electricity storage device at the side of the first end part.

3. The electricity storage module according to claim 2, wherein
the predetermined load is equal to or more than 4 kN and not more than 80 kN.

4. The electricity storage module according to claim 2, wherein
the spacer is rectangular,
the spacer comprises:
a convex part that is configured to protrude in the arranged direction;
an outer edge part that is configured to surround the convex part; and
a joint part that is configured to couple the convex part and the outer edge part,
the joint part is formed in a thin-walled shape which is thinner than a thickness of the convex part or the outer edge part, and
when the load being larger than the predetermined load is applied along the arranged direction, the joint part is broken and thus a thickness becomes smaller.

5. The electricity storage module according to claim 2, wherein
the spacer comprises:
a convex part that is configured to protrude in the arranged direction;
a concave part that is provided on an opposed surface being opposed to the convex part; and
a caulking claw part that is opposed to the convex part and that is formed at an entrance of the concave part,
the convex part is arranged under a state of coming into contact with the caulking claw part so as to form a gap between the convex part and the concave part, and
when the load being larger than the predetermined load is applied along the arranged direction, the convex part and the concave part fit to each other and thus a thickness becomes smaller.

6. The electricity storage module according to claim 2, wherein
the spacer is provided between an electricity storage device at a side of the second end part and the second end plate, too.
